(19) United States
(12) Patent Application Publication
(10) Pub. No.: US 2023/0110012 A1
(43) Pub. Date: Apr. 13, 2023

(54) ADAPTIVE APPLICATION RESOURCE USAGE TRACKING AND PARAMETER TUNING

(71) Applicant: Dell Products L.P., Round Rock, TX (US)

(72) Inventors: Fnu Jasleen, Austin, TX (US); Farzad Khosrowpour, Pflugerville, TX (US)

(73) Assignee: Dell Products L.P., Round Rock, TX (US)

(21) Appl. No.: 17/450,214

(22) Filed: Oct. 7, 2021

(51) Int. Cl. G06F 9/50; G06F 11/30; G06F 11/34; G06N 20/00

(52) U.S. Cl. CPC G06F 9/5055; G06F 11/3051; G06F 11/3409; G06N 20/00; G06F 2209/5019; G06F 2209/501

(57) ABSTRACT

An information handling system may predict, for a first time period, a first resource usage of a first information handling system resource for an application. The information handling system may also predict, for the first time period, a second resource usage level of a second information handling system resource different from the first information handling system resource for the application. The information handling system may adjust one or more performance parameters for the information handling system based on the first resource usage level and the second resource usage level.

### FIELD OF THE DISCLOSURE

The present disclosure generally relates to information handling systems, and more particularly relates tracking resource usage of and adjusting performance parameters of information handling systems.

### BACKGROUND

As the value and use of information increase, individuals and businesses seek additional ways to process and store information. One option is an information handling system. An information handling system generally processes, compiles, stores, and/or communicates information or data for business, personal, or other purposes. Because technology and information handling needs may vary between different applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, reservations, enterprise data storage, or global communications. In addition, information handling systems may include a variety of hardware and software resources that may be configured to process, store, and communicate information and may include one or more computer systems, data storage systems, and networking systems.

Information handling systems may execute many different applications, such as word processors, gaming applications, video viewing and editing applications, spreadsheet applications, and other applications. Different applications may require different amounts of system resources for execution. When multiple information handling system applications and/or processes are executed concurrently, applications and/or processes may have overlapping demands for system resources, such as processing capacity, graphics capacity, I/O capacity, and other information handling system resources. Resources of an information handling system may be limited, and thus applications executed by an information handling system concurrently may compete for resources.

An operating system of an information handling system may allocate resources to one or more applications and/or processes for use by the applications and/or processes. In some cases, applications executed by an information handling system may include multiple functions, requiring different amounts of system resources over time depending on which functions are chosen by a user. Poorly allocated information handling system resources may cause applications to run slowly, or even freeze and crash, negatively impacting a user experience.

Shortcomings mentioned here are only representative and are included simply to highlight that a need exists for improved information handling systems. Embodiments described herein address certain shortcomings but not necessarily each and every one described here or known in the art. Furthermore, embodiments described herein may present other benefits than, and be used in other applications than, those of the shortcomings described above.

### SUMMARY

An information handling system may adjust performance parameters based on predictions as to usage of a plurality of resources of the information handling system by an application. For example, an information handling system may predict, for an application executed by the information handling system, a first resource usage level for a first resource of the information handling system, such as processing capacity, and a second resource usage level for a second resource of the information handling system, such as input/output (I/O) capacity. Based on the predictions as to usage of the two resources by the application, the information handling system may adjust one or more performance parameters, such as a displayed framed per second or a power of a central processing unit (CPU) of the information handling system. Adjustment of performance parameters based on a plurality of resource usage predictions for an application may allow the information handling system to meet resource demands of the application, reducing a likelihood of the application operating slowly, freezing, or crashing, thereby enhancing a user experience.

The information handling system may apply an unsupervised machine learning model to determine thresholds for resource usage for multiple resources by an application, such as processing capacity, I/O capacity, graphics capacity, and other resources. For example, the information handling system may provide the unsupervised machine learning model with training data regarding execution of the application, the operation of the information handling system while the application is being executed, and other operating characteristics of the information handling system to allow the unsupervised machine learning model to determine resource usage thresholds and/or ranges at which resource usage by the application should be classified as high, medium, or low. In some embodiments, the information handling system may provide the unsupervised machine learning model with training data regarding execution of other applications to determine resource usage prediction thresholds and/or ranges at which usage of resources by the application should be classified as high, medium, or low. The resource usage thresholds and/or ranges may each be determined for multiple resources used by the application. For example, a high resource usage range for usage of graphics capacity and a high resource usage range for usage of processing capacity by the application may be determined. The resource usage thresholds may be used in predicting resource usage levels for the application, such as by predicting that a resource usage level of a first resource by an application will be high. Use of flexibly determined thresholds in determining application resource usage levels of multiple resources may allow for better tuning of information handling system performance parameters.

An example method for managing information handling system performance may include predicting, for a first time period, a first resource usage level of a first information handling system resource for an application of the information handling system. The method may also include predicting, for the first time period, a second resource usage level of a second information handling system resource different from the first information handling system resource for the application. The predicted resource usage levels for the first and second resources may be determined using a supervised machine learning model, such as a neural net, to predict a level of resource usage of multiple resources by the application. In some embodiments, such a prediction may indicate whether the application is particularly sensitive to being allocated a demanded amount of a particular system resource.

Predicting the first usage level may, in some embodiments, include determining whether a first predicted usage of the first resource by the application should be classified as a low usage level of the first resource, a medium usage level of the first resource, or a high usage level of the first resource. Likewise, predicting the second usage level may include determining whether a second predicted usage of the second resource by the application should be classified as a low usage level of the second resource, a medium usage level of the second resource, or a high usage level of the second resource.

Thresholds for resource usage levels for each of a plurality of information handling system resources used by an application may be determined by an information handling system. For example, a low resource usage threshold for a first resource may be determined for an application such that when a usage of the first resource by the application is below the threshold the resource usage level of the application may be a low resource usage level. Likewise, a high resource usage threshold for the first resource may be determined for the application such that when a usage of the first resource by the application is above the high resource usage threshold, the resource usage level of the application may be a high resource usage level. A usage of the first resource by the application that falls between the low resource usage threshold and the high resource usage threshold may be a medium resource usage level. In some embodiments, such thresholds may be determined for classes of applications for multiple resources. As one example, low and high resource usage thresholds may be set for all gaming applications for each of graphics capacity, processing capacity, and I/O capacity of the information handling system. Categorizing usage levels into three categories, such as low, medium, and high, may enhance efficiency in determining usage levels, by requiring determination of two thresholds, instead of three, or more. Furthermore, categorization of application resource demands into three categories may enhance efficiency of allocation of resources by reducing a complexity of data analyzed when determining which system performance parameters to adjust. In some embodiments, additional resource usage thresholds may be determined for further granularity, allowing for four or more resource usage level classifications.

As one example, an information handling system may determine a first range of a first usage parameter corresponding to the first information handling system resource for the low usage level. For example, the first usage parameter may be a percentage of a maximum processing capacity of the information handling system requested by the application. The information handling system may determine that when a predicted percentage of the maximum processing capacity of the information handling system requested by the application is below a first threshold, such as below 30%, the predicted usage level of the processing capacity of the information handling system should be classified as low. Thus, the first range may be from 30% of processing capacity to 0% of processing capacity of the information handling system. Similarly, the information handling system may also determine a second range of the first usage parameter corresponding to the first information handling system resource for the medium usage level. Likewise, the information handling system may also determine a third range of the first usage parameter corresponding to the first information handling system resource for the high usage level. A similar determination of ranges of a second usage parameter for usage levels of the second resource may also be performed. Determination of such ranges may, for example, include determinations of usage thresholds as described herein. Thus, the information handling system may determine ranges of usage parameters for predicting a usage level of an application of an information handling system.

In some embodiments, the information handling system may apply a machine learning model, such as an unsupervised machine learning model, to determine the ranges of the usage levels of the information handling system resources that should be classified as low, medium, and high usage levels. For example, the machine learning model may receive training data for training the machine learning model, such as data regarding operation of the information handling system, such as temperature data, resource usage data, power usage data, and other data and process level data of the application. The machine learning model may determine the ranges for the resource usage levels based on such data. In some embodiments, more granularity may be added, allowing for determination of ranges of usage levels beyond the low, medium, and high usage levels. In some embodiments, ranges for low, medium, and high usage of a first resource may be determined for a classification of applications, such as productivity or gaming applications.

Based on the first and second predicted resource usage levels of the first and second resources, the information handling system may adjust one or more performance parameters for the information handling system. For example, if the information handling system predicts that a resource usage level of a processing capacity of an information handling system will be high while a resource usage of a I/O capacity of the information handling system may be low, the information handling system may increase a power of the central processing unit (CPU) in response. Other examples of performance parameters may include a displayed frames per second of the information handling system, a computed frames per second of the information handling system, a frequency of a CPU of the information handling system, a refresh rate of a display of the information handling system, a brightness of a display of the information handling system, and other performance parameters. Adjustment of such performance parameters based on predicted resource usage levels may reduce a likelihood that the application will run slowly, freeze, or crash.

In some embodiments, the information handling system may continuously predict resource usage levels and may continuously adjust performance parameters based on the predicted resource usage levels. For example, resource demands of an application, or multiple applications, executed by an information handling system may change over time. In some embodiments, an information handling system may predict, for a second time period, a third resource usage level of the first information handling system resource for the application and may predict for the second time period, a fourth resource usage level of the second information handling system resource for the application. Based on the predicted third and fourth resource usage levels of the first and second resources, the information handling system may further adjust the one or more performance parameters of the information handling system. Thus, prediction of resource usage levels at multiple times during execution of an application may allow for adjustment of performance parameters based on multiple predicted resource demands of an application during multiple time periods.

In some embodiments, an information handling system may include a memory and a processor for performing the methods described herein. A computer program product may include a non-transitory computer-readable medium including instructions for causing an information handling system to perform the method described herein.

The foregoing has outlined rather broadly certain features and technical advantages of embodiments of the present invention in order that the detailed description that follows may be better understood. Additional features and advantages will be described hereinafter that form the subject of the claims of the invention. It should be appreciated by those having ordinary skill in the art that the conception and specific embodiment disclosed may be readily utilized as a basis for modifying or designing other structures for carrying out the same or similar purposes. It should also be realized by those having ordinary skill in the art that such equivalent constructions do not depart from the spirit and scope of the invention as set forth in the appended claims. Additional features will be better understood from the following description when considered in connection with the accompanying figures. It is to be expressly understood, however, that each of the figures is provided for the purpose of illustration and description only and is not intended to limit the present invention.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 is a block diagram of an example information handling system according to some embodiments of the disclosure.

FIG. 2 an example timeline of resource demands on an information handling system by a plurality of processes and applications according to some embodiments of the disclosure.

FIG. 3 is an example timeline of resource demands on an information handling system by an application according to some embodiments of the disclosure.

FIG. 4 is a block diagram of an example system for tuning performance parameters of an information handling system based on resource usage according to some embodiments of the disclosure.

FIG. 5 is an example timeline of resource demand levels by an application according to some embodiments of the disclosure.

FIG. 6 is a block diagram of an example method for tuning of performance parameters based on a plurality of resource usage level predictions according to some embodiments of the disclosure.

FIG. 7 is a block diagram of an example method of establishing ranges for resource usage levels according to some embodiments of the disclosure.

FIG. 8 is a block diagram of an example method for operating a machine learning model module to predict resource usage levels of an application according to some embodiments of the disclosure.

### DETAILED DESCRIPTION OF DRAWINGS

The following description in combination with the Figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings. However, other teachings can certainly be used in this application. The teachings can also be used in other applications and with several different types of architectures.

For purposes of this disclosure, an information handling system (IHS) may include any instrumentality or aggregate of instrumentalities operable to compute, determine, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (e.g., desktop or laptop), tablet computer, a two-in-one laptop/tablet computer, mobile device (e.g., personal digital assistant (PDA), smart phone, tablet computer, or smart watch), server (e.g., blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more virtual or physical buses operable to transmit communications between the various hardware and/or software components.

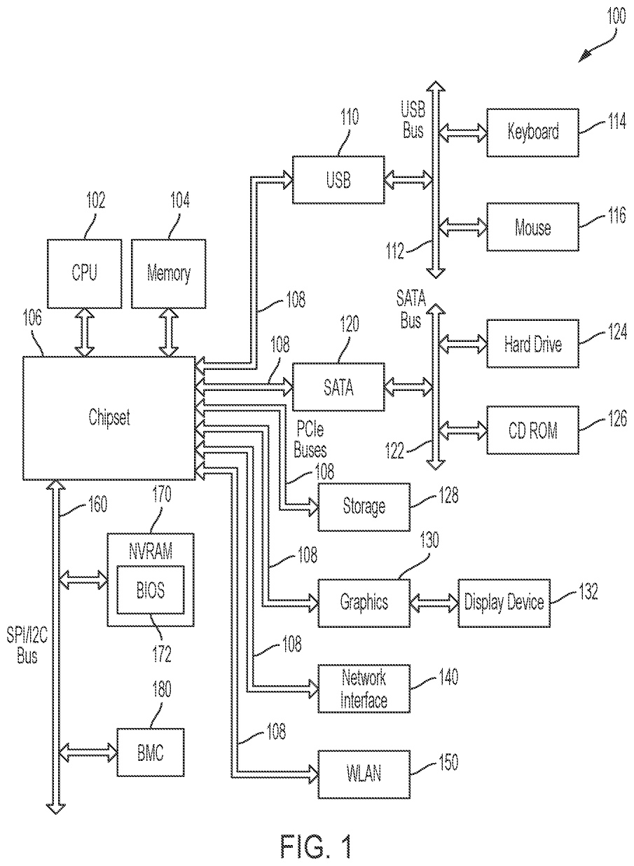

FIG. 1 illustrates an example information handling system 100. Information handling system 100 may include a processor 102, a memory 104, a chipset 106, one or more PCIe buses 108, a universal serial bus (USB) controller 110, a USB bus 112, a keyboard device controller 114, a mouse device controller 116, a configuration a SATA bus controller 120, a SATA bus 122, a hard drive device controller 124, a compact disk read only memory (CD ROM) device controller 126, a storage 128, a graphics device controller 130, a network interface controller (NIC) 140, a wireless local area network (WLAN) or wireless wide area network (WWAN) controller 150, a serial peripheral interface (SPI) bus 160, a NVRAM 170 for storing BIOS 172, and a baseboard management controller (BMC) 180. In one example embodiment, chipset 106 may be directly connected to an individual end point via a PCIe root port within the chipset and a point-to-point topology as shown in FIG. 1. BMC 180 may be referred to as a service processor or embedded controller (EC). Capabilities and functions provided by BMC 180 may vary considerably based on the type of information handling system. For example, the term baseboard management system may be used to describe an embedded processor included at a server, while an embedded controller may be found in a consumer-level device. As disclosed herein, BMC 180 represents a processing device different from CPU 102, which provides various management functions for information handling system 100. For example, an embedded controller may be responsible for power management, cooling management, and the like. An embedded controller included at a data storage system may be referred to as a storage enclosure processor or a chassis processor.

System 100 may include additional processors that are configured to provide localized or specific control functions, such as a battery management controller. Bus 160 can include one or more busses, including a SPI bus, an I2C bus, a system management bus (SMBUS), a power management bus (PMBUS), and the like. BMC 180 can be configured to provide out-of-band access to devices at information handling system 100. As used herein, out-of-band access herein refers to operations performed prior to execution of BIOS 172 by processor 102 to initialize operation of system 100.

BIOS 172 may include instructions executable by CPU 102 to initialize and test the hardware components of system 100, and to load a boot loader or an operating system (OS) from a mass storage device. BIOS 172 additionally may provide an abstraction layer for the hardware, such as a consistent way for application programs and operating systems to interact with the keyboard, display, and other input/output devices. When power is first applied to information handling system 100, the system may begin a sequence of initialization procedures, such as a BIOS boot procedure. During the initialization sequence, also referred to as a boot sequence, components of system 100 may be configured and enabled for operation, and device drivers may be installed. Device drivers may provide an interface through which other components of the system 100 can communicate with a corresponding device. BIOS, as used herein, may also refer to a unified extensible firmware interface (UEFI).

In some embodiments, one or more BIOS firmware modules to be loaded and executed by the BIOS 172 during booting of the information handling system may be stored in a memory 170 of the BIOS 172. One or more BIOS firmware modules to be loaded and executed by the BIOS 172 during booting of the information handling system 100 may also be stored in system storage 128, such as in a hard drive of the information handling system or in a solid-state drive of the information handling system. In some embodiments, such BIOS firmware modules may be stored in hard drive 124. For example, available space in the BIOS memory 170, such as in a serial peripheral interface flash memory, may be limited. To allow for a more extensive array of BIOS firmware modules to be loaded and executed by the BIOS 172, BIOS firmware modules, such as BIOS feature sets, BIOS recovery files, drivers or driver components, telemetry data, and other BIOS firmware modules, along with a host operating system, recovery operating system boot sensitive files, may be stored in an extended system partition of a hard drive or solid state drive of the information handling system accessible to the BIOS 172. File paths to the information stored in an extended system partition on a hard drive or solid-state drive of the information handling system may be hard coded into the BIOS 172 of the information handling system 100. BIOS firmware modules may, for example, include BIOS drivers and other BIOS firmware components. In some embodiments, BIOS firmware modules may include third party firmware modules, such as third-party drivers, that may be hosted and run by a BIOS, such as to collect telemetry from one or more devices, such as components of the information handling system, during booting of the information handling system.

Information handling system 100 may include additional components and additional busses, not shown for clarity. For example, system 100 may include multiple processor cores, audio devices, and the like. While a particular arrangement of bus technologies and interconnections is illustrated for the purpose of example, one of skill will appreciate that the techniques disclosed herein are applicable to other system architectures. System 100 may include multiple CPUs and redundant bus controllers. One or more components may be integrated together. For example, portions of chipset 106 can be integrated within CPU 102. Additional components of information handling system 100 may include one or more storage devices that may store machine-executable code, one or more communications ports for communicating with external devices, and various input and output (I/O) devices, such as a keyboard, a mouse, and a video display.

An information handling system, such as information handling system 100, may execute multiple applications having differing demands on various information handling system resources. Furthermore, resource demands of an application executed by an information handling system may vary over time. Resource demands by applications may include demands on the CPU 102 of the information handling system 100, demands on a memory 104 of the information handling system, I/O demands, such as demands on a storage 128, a hard drive 124, a CD ROM drive 126, a network interface 140, and/or a WLAN 150 of the information handling system 100, demands on a graphics card of an information handling system, such as graphics card 130, and other demands on other system resources. Applications, as used herein, may include system processes executed by an operating system of an information handling system, applications executed by an operating system of an information handling system, and other instructions executed by an operating system of an information handling system.

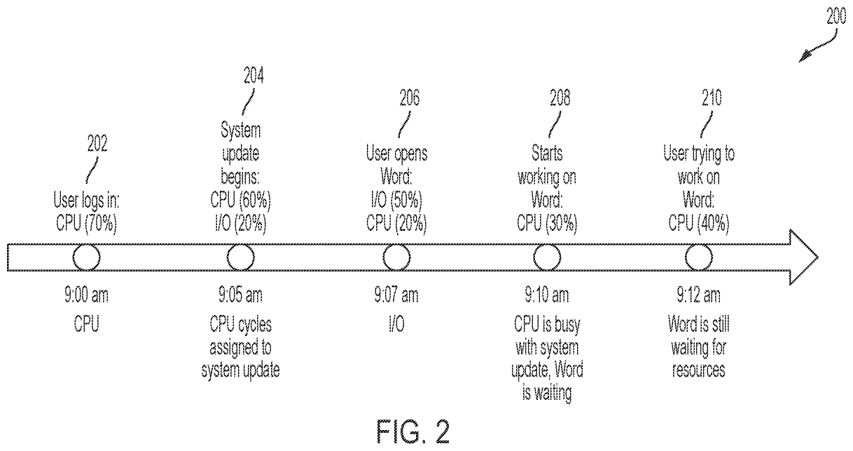

As discussed herein, resource demands by applications executed by an information handling system may vary over time. An example timeline 200 of resource demands by applications executed by an information handling system is shown in FIG. 2. A first timeline event 202 may occur at a first time when a user logs in to an information handling system. The user login may require initialization of various system processes and applications of the information handling system. The user login process at event 202 may demand CPU resources of the information handling system, such as 70% of a processing capacity of the information handling system, to complete user login processes. After the first timeline event 202, a second timeline event 204 may occur at a second time when the information handling system begins a system update process. For example, one the user login has completed, the operating system may begin a system update process to update the operating system and/or one or more applications or other software components of the information handling system. The system update process at event 204 may have resource demands that differ from the user login process at event 202. For example, the system update process may demand 60% of a processing capacity of the information handling system and 20% of an I/O capacity of the information handling system. Thus, CPU cycles may be assigned to the system update process to meet the demands of the system update process.

While the system update process is ongoing, a third timeline event 206 may occur at a third time when a user of the information handling system opens an application of the information handling system, such as a word processing application of the information handling system. The word processing application may have demands for system resources, such as processing capacity, that compete with the demands of the update process. For example, the word processing application, when opening, may demand 20% of a processing capacity of the information handling system and 50% of an I/O capacity of the information handling system. Thus, both the word processor and the system update process may demand processing capacity and I/O capacity of the information handling system at event 206. At event 208, a user may begin working in the word processing application, such as editing a document in the word processing application. At event 208, for example, the word processing application may have completed opening, and may no longer demand I/O capacity of an information handling system, but the processing capacity demands of the word processing application may have increased to 30% of a processing capacity of the information handling system. As processing capacity of the information handling system is allocated to the system update process, the word processing application may operate slowly, or even freeze. At event 210, the processing capacity demands of the word processing application may further increase to 40% of a processing capacity of the information handling system. For example, the word processing application may demand processing resources at event 208, but the processing resources may be allocated to performance of the system update described at event 204. Thus, the word processing application may be waiting for processing resources at events 208 and 210, which are allocated to the system update process, causing the word processing application to run slowly. Thus, the information handling system may re-allocate resources from the update process to the word processing application being used by the user, but such re-allocation may take time. Before sufficient resources are allocated to the word processing application, the application may operate slowly, freeze, or even crash, negatively impacting a user experience.

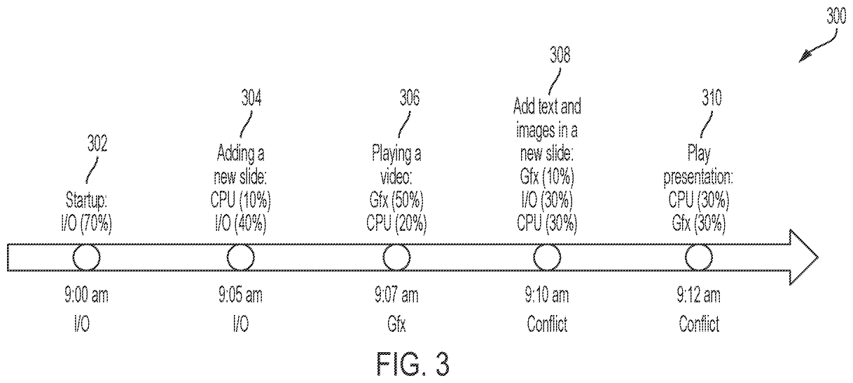

Furthermore, a single application executed by an information handling system may require multiple different resources and combinations of resources during multiple time periods of execution. Characterization and assignment of resources to an application based on demand for a single resource, such as processing capacity, can reduce system efficiency by failing to allow for parameter tuning and resource allocation based on a combination of resources required by the application. For example, if an application is characterized merely by its processing capacity demands, but also requires I/O capacity, resources may be assigned and system parameters may be tuned to optimize processing capacity allocation to the application, while failing to account for the I/O capacity demands of the application. The resulting lack of efficiency can cause the application to run slowly, freeze, and even crash, negatively impacting a user experience. An example timeline 300 of resource demands by an application is shown in FIG. 3. At a first timeline event 302, an application, such as a presentation creation application, may be activated. Activation of such an application may demand I/O capacity of an information handling system, such as 70% of an I/O capacity of an information handling system, to load and initialize the application. Thus, at startup of the application, the application may be characterized as demanding I/O resources.

After the application has initialized, at a second timeline event 304, a user may perform an action in the application, such as adding a new slide. When the action is performed, resource demands of the application may differ from the resource demands at startup. For example, when the new slide is added, the application may demand 10% of a processing capacity of the information handling system and 40% of an I/O capacity of the information handling system. If the application is characterized only by the primary resource required by the application, such as by a demand for I/O capacity, performance parameters and resource allocation of the information handling system may not be optimized for the resource demands of the application. For example, at event 304, the performance parameters and resource allocation of the information handling system may be optimized to meet the I/O demands of the application, but not the processing demands of the application.

Over the course of operation of the application, resource demands may change further. For example, at a third timeline event 306, a user may play a video in the application. Playing the video may cause the application to demand 50% of a graphics capacity of the information handling system and 20% of a processing capacity of the information handling system. Thus, if resource allocation and performance parameter adjustment are performed based only on the graphics capacity demands of the application, execution of the application may not be optimized based on the full resource demands of the application.

Similarly, at a fourth timeline event 308, new text and images may be added to a slide, and demands of the application may shift to 10% of a graphics capacity of the information handling system, 30% of an I/O capacity of the information handling system, and 30% of a processing capacity of the information handling system. Such resource demands may introduce still further conflicts, with an equal percentage system resource demand being made on both processing capacity and I/O capacity of the information handling system. Thus, if equal demands are placed on two system resources at a same time, the information handling system may be unable to determine a single resource requirement on which to base resource allocation and/or performance parameter tuning. In some cases, the information handling system may resort to picking one of the two equally-demanded resources. Likewise, at a fifth timeline event 310, such as playing of the presentation, resource demands of the application may shift yet again, demanding 30% of a processing capacity and 30% of a graphics capacity of the information handling system. A similar conflict may arise under such circumstances. Thus, resource demands of an application may change over time, and allocating resources and tuning performance parameters of an information handling system based on a single resource demanded by an application may lead to inefficiency. Furthermore, an information handling system may demand multiple system resources at a given time, and allocating resources and tuning performance parameters of an application based on a single resource demand at a given time, or a most demanded resource over the course of operation of the application, may also reduce efficiency. For example, if the application is characterized as simply a high processing usage application and performance parameters of the information handling system are tuned to enhance only processing efficiency while the application is being executed, performance of the application may be impacted when the application performs tasks that require resources other than processing power. Such reductions in efficiency may cause applications to run slowly, freeze, or even crash.

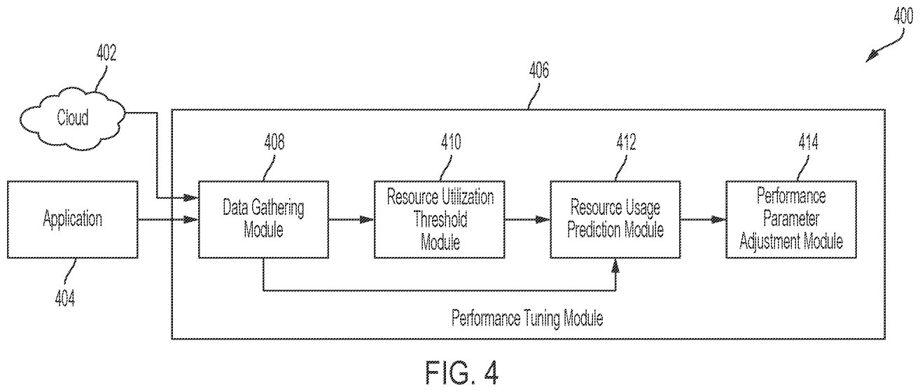

An information handling system may enhance efficiency of execution of applications by predicting multiple resource demands by an application at multiple times and adjusting performance parameters of the information handling system based on such predictions. An example system 400 for tuning performance parameters of an information handling system is shown in FIG. 4. An information handling system may execute a variety of applications, such as productivity applications, gaming applications, media applications, and other applications. A performance tuning module 406 of an information handling system may adjust performance parameters of an information handling system based on predictions of resource usage requirements of an application 404. The performance tuning module 406 may, for example, include a performance tuning algorithm for tuning information handling system performance parameters based on application resource demands.

The performance tuning module 406 may include multiple modules for performing various different functions for tuning performance of the information handling system. A data gathering module 408 may gather data from a variety of sources regarding operation of the information handling system. For example, the data gathering module 408 may receive application data from an application 404 executed by the information handling system, such as process level data of the application 404 and usage data of the application 404, such as resource demands of the application when certain features of the application 404 are activated and information regarding a speed with which the application 404 responds to user requests. The application data received by the data gathering module 408 may, for example, include data regarding resource usage of multiple information handling system resources, such as a percentage of graphics capacity of the information handling system used by the application and/or a percentage of processing capacity of the information handling system used by the application when certain tasks are performed by the application. The application data may also, for example, include performance data regarding operation of the application, such as a speed with which the application responds to a user request when certain amounts of resources are allocated to the application. The data gathering module 408 may further receive process level data and usage data of other applications executed by the information handling system. The data gathering module 408 may also receive data regarding operation of the information handling system, such as resource usage of the information handling system, resource capacity of the information handling system, such as an amount of graphics capacity, processing capacity, and I/O capacity of the information handling system, telemetry data of the information handling system, such as temperature and power usage data of the information handling system, and other data regarding operation of the information handling system. In some embodiments, the data gathering module 408 may also receive application and information handling system data from the cloud 402, such as data gathered regarding operation of the application 404, or other applications, on other information handling systems. The data gathered by the data gathering module may be used as training data for training an unsupervised machine learning model of a resource utilization threshold module 410 and/or a supervised machine learning model of a resource usage prediction module 412 of the performance tuning module 406.

The data gathering module 408 may provide the gathered data, such as information handling system data and application data, to a resource utilization threshold module 410 to establish a plurality of resource utilization thresholds or ranges for categorization of predicted resource demands by the application 404. In some embodiments, the resource utilization threshold module 410 may include an unsupervised machine learning model for establishing resource usage thresholds and/or ranges for classifying resource usage by the information handling system. Establishment of resource usage thresholds may, for example, include establishment of ranges for classification of resource usage predictions for the application of low, medium, and high. For example, a first resource usage threshold may be established at a first amount, such as 30% of a system resource, to delineate the boundary between low usage of the resource and medium usage of the resource. A second resource usage threshold may be established at a second amount, such as 70% of the system resource, to delineate the boundary between medium usage of the resource and high usage of the resource. Thus, if a prediction of resource usage indicates that the application will use less than 30% of a system resource capacity, the application's predicted resource usage level may be classified as low, while if a prediction of resource usage indicates that the application will use 30% or more of the system resource capacity, but below 70%, the application's predicted resource usage level may be classified as medium. The resource utilization threshold module 410 may establish resource usage level thresholds and/or ranges for multiple information handling system resources. For example, low, medium, and high resource usage ranges and/or thresholds may be established for usage of each of a graphics capacity of the information handling system, a processing capacity of the information handling system, an I/O capacity of the information handling system, a storage capacity of the information handling system, a network capacity of the information handling system, and other resources of the information handling system by the application. In some embodiments, resource usage level thresholds and/or ranges may be established for usage of each of a plurality of resources by each of a plurality of applications. In some embodiments, resource usage level thresholds and/or ranges may be established for usage of each of the plurality of resources by classes of applications, rather than individual applications, such as gaming applications, productivity applications, and other applications. In some embodiments, more granularity in resource usage thresholds/levels may be determined, such that greater than two thresholds and/or three ranges for resource usage classification are determined for each resource. Thus, the resource utilization threshold module 410 may establish resource utilization thresholds and/or ranges for categorizing resource usage by an application 404 executed by the information handling system.

In some embodiments, the resource utilization threshold module 410 may also take into account sensitivity of the application to provisioning of a demanded resource allocation in establishment of the resource usage level thresholds/ranges. The thresholds and/or ranges for the resource usage levels may, for example, be data-driven, rather than solely based on resource utilization by the applications. For example, thresholds for medium and high resource usage levels may be set at higher resource capacity percentages if the application is less sensitive to provisioning of a demanded amount of a resource, while thresholds for medium and high resource usage levels may be set at lower resource capacity percentages if the application is more sensitive to provisioning of a demanded amount of the resource. For example, if an application experiences substantial slowdown when an insufficient amount of information handling system processing capacity is allocated to the application, a threshold for a high resource usage level may be set at 60%, while if an application does not experience substantial slowdown when an insufficient amount of information handling system processing capacity is allocated to the application, the threshold for the high resource usage level may be set at 80%. Thus, in addition to accounting for resource usage percentages in establishing resource usage level thresholds and ranges, an unsupervised machine learning model of the resource utilization threshold module 410 may take sensitivity of the application to adequate provisioning of the resource, such as sensitivity of the application to key performance indicators associated with the resource. As one example, if the application is particularly sensitive to bandwidth or I/O operations per second, thresholds and/or ranges for system I/O capacity and/or storage capacity usage by the application may be established accordingly. Establishment of thresholds and/or ranges for resource usage using a machine learning model, such as an unsupervised machine learning module, may allow for flexible classification of application resource usage predictions based on the specific needs and performance of the application, or class of applications, further enhancing tuning of information handling system performance parameters to the needs of an application.

In addition to determining resource utilization thresholds and/or ranges, the resource utilization threshold module 410 may also determine information handling system performance parameters that should be adjusted when an application's usage of one or more resources is determined to be at a particular resource usage level. Information handling system performance parameters may, for example, include a power of a processor of the information handling system, a frequency of the processor of the information handling system, a computed frames per second of the information handling system, a displayed frames per second of the information handling system, a time of completion (TOC) of a task performed by the information handling system, a refresh rate of a display of the information handling system, a brightness of a display of the information handling system, and other information handling system performance parameters. In some embodiments, such parameters may be adjusted per process. In some embodiments, system performance parameters may also include networking performance parameters, such as a speed with which data is transmitted from the information handling system. Thus, a determination of thresholds and/or ranges for classification of usage of a processing power of the information handling system may include associating an increase in a frequency and/or power of a processor of an information handling system when a resource usage level of the processor by the application is predicted to be high. In some embodiments, certain combinations of resource usage levels may be associated with adjustment of certain parameters. For example, a reduction in a refresh rate of a display of an information handling system may be associated with a high I/O resource usage level and a low graphics resource usage level by the application. Thus, resource usage levels may be associated with adjustment of information handling system performance parameters.

The established resource usage thresholds and/or ranges may be provided by the resource utilization threshold module 410 to a resource usage prediction module 412. The resource usage prediction module 412 may predict usage requirements of multiple information handling system resources. For example, the resource usage module may predict that a usage level of an application of a first resource, such as a processing capacity of the information handling system, will be high and that a usage level of a second resource, such as an I/O capacity of the information handling system, will be low. The resource usage prediction module 412 may make such predictions using the thresholds provided by the resource utilization threshold module for each resource for the application 404. In some embodiments, the resource usage prediction module 412 may receive data regarding the application 404 and/or information handling system operation from the data gathering module 408 and may use such data in making a prediction. For example, the resource usage prediction module 412 may receive data regarding past usage and/or resource demands of the application 404 and current usage and/or resource demands of the application 404 and may use such information in prediction a resource usage of the application 404. For example, the resource usage prediction module 412 may predict that a usage of the application of a processing capacity of the information handling system will be 75% of the processing capacity of the information handling system. Using the thresholds provided by the resource utilization threshold module 410, such as a threshold of 70% for classification of processing capacity usage as high, the resource usage prediction module may predict that a usage of a processing capacity of the information handling system by the application 404 will be high. The resource usage prediction module 412 may predict resource usage levels for multiple information handling system resources by the application 404, such as processing capacity, storage capacity, graphics capacity, network capacity, I/O capacity, and other resource capacities of the information handling system.

In some embodiments, the resource usage prediction module 412 may predict resource usages of the application 404 for multiple times. For example, the resource usage prediction module may predict that, at a first time, a resource usage level of an application will be high for graphics capacity of the information handling system and low for processing capacity, while at a second time, a resource usage level of the application will be medium for processing capacity and low for graphics capacity.

The resource usage prediction module 412 may apply a machine learning model, such as a supervised neural net, to predict resource usage by the application 404. For example, the resource usage prediction module 412 may analyze past behavior of the information handling system and/or application 404 along with a current status of the information handling system and/or application 404 to predict a resource usage by the application 404.

The resource usage prediction module 412 may provide the predicted resource usage levels for the application to a performance parameter adjustment module 414. The performance parameter adjustment module 414 may adjust one or more performance parameters of the information handling system based on multiple predicted resource usage levels. For example, the performance parameter adjustment module may adjust a displayed frames per second of the information handling system based on a received resource usage level of a graphics capacity and a processing capacity of the information handling system. Thus, performance parameters of the information handling system may be adjusted based on predicted resource usage levels of multiple resources of the information handling system, such as processing capacity, graphics capacity, and I/O capacity. Such adjustment may enhance execution of the application using the resources, avoiding application delay due to inadequate allocation of resources and unoptimized information handling system performance parameters.

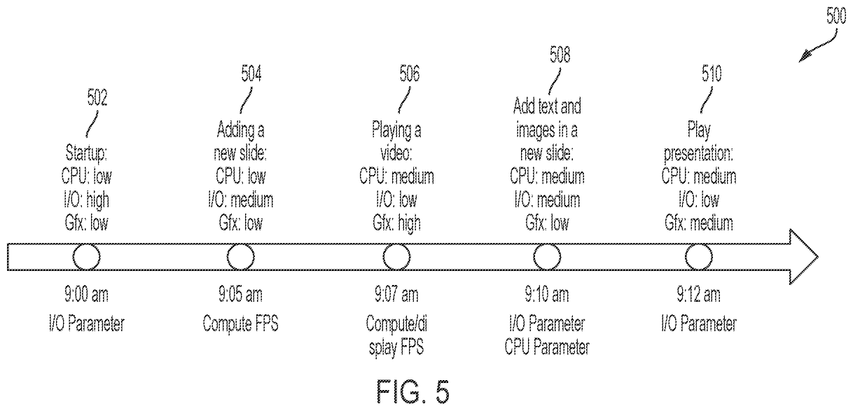

An example timeline 500 of execution of an application by an information handling system implementing a performance tuning module is shown in FIG. 5. At a first timeline event 502, an application may be initialized. For example, a presentation creation productivity application may be opened by a user of the information handling system. At startup, the information handling system may predict that the presentation creation application may have a low resource demand on a processing capacity of the information handling system, a high resource demand on an I/O capacity of the information handling system, and a low resource demand on a graphics capacity of the information handling system. For example, a resource usage prediction module, such as module 412 of FIG. 4, may determine using resource usage ranges and/or thresholds received from a resource utilization threshold module 410, predicted resource usage thresholds for the first timeline event 502. Based on the predicted resource usage levels, the information handling system may adjust one or more performance parameters. For example, a parameter associated with high I/O performance, such as a read/write speed, may be adjusted based on the high I/O resource level, the low CPU resource level, and the low graphics resource level.

At a second timeline event 504, a user may add a new slide to a presentation. The information handling system may predict that a processing capacity usage level will be low, an I/O capacity usage level will be medium, and a graphics capacity usage level will be low. Based on the usage levels for graphics, I/O, and processing capacity of the information handling system by the application, the information handling system may adjust one or more performance parameters, such as a computed frames per second of the information handling system.

At a third timeline event 506, a user may play a video in the presentation application. For the third timeline event 506, the information handling system may predict a medium processing capacity usage level, a low I/O capacity usage level, and a high graphics capacity usage level. Based on the predicted processing, I/O, and graphics capacity usage levels, the information handling system may, for example, adjust a computed and/or displayed frames per second of the application to enhance a graphics performance of the application.

At a fourth timeline event 508, a user may add text and images to a new slide in the presentation application. For the fourth timeline event 508, the information handling system may predict a medium processing capacity usage level, a medium I/O capacity usage level, and a low graphics capacity usage level for the application. Based on the predicted processing, I/O, and graphics capacity usage levels, the information handling system may, for example, adjust an I/O parameter, such as a read/write speed, and/or a processing parameter, such as a frequency or power of a processor of the information handling system, to enhance I/O operation and processing operation of the application.

At a fifth timeline event 508, a user may play the presentation. For the fifth timeline event 510, the information handling system may predict a medium processing capacity usage, a low I/O capacity usage, and a medium graphics capacity usage for the application. Based on the predicted processing, I/O, and graphics capacity usage levels, the information handling system may, for example, adjust an I/O parameter to account for the low I/O usage of the application at the fifth timeline event 510. Thus, the information handling system may employ a performance tuning module to adjust performance parameters based on predicted resource usage of multiple resources by an application. Prediction of multiple resource levels for multiple resources and adjustment of performance parameters based on such predictions can allow the information handling system to enhance performance of an application, reducing application delays.

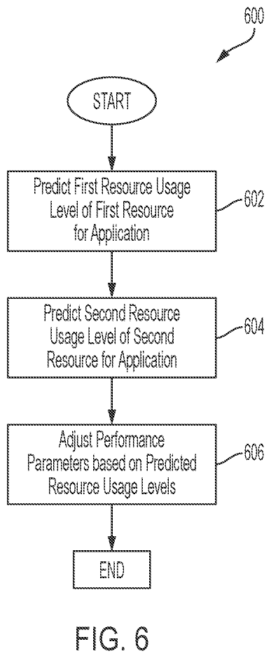

An example method 600 for adjustment of information handling system performance parameters based on predictions of usage of a plurality of resources by an application is shown in FIG. 6. The method 600 may begin, at step 602, with prediction of a first resource usage level of a first resource for an application. For example, an information handling system may predict an amount of a first resource that will be used by an application at a first time. Resources may include, for example, a processing capacity of the information handling system, a graphics capacity of the information handling system, an I/O capacity of the information handling system, a storage capacity of the information handling system, a network capacity of the information handling system, and other resources. In some embodiments, prediction of a first resource usage level may include prediction of whether the first resource usage level should be classified as a low resource usage level, a medium resource usage level, or a high resource usage level. Such classification may, for example, be made based on resource usage thresholds and/or ranges established by a resource utilization threshold selection module, such as an unsupervised machine learning model module. In some embodiments prediction of the first resource usage level may be performed by a machine learning model of the information handling system, such as a supervised neural net, based on, for example, past data regarding resource usage by and performance of the application and/or other applications. Prediction of an I/O capacity usage of an application may, for example, include multiple subcategories, such as a bandwidth usage of the application, an input/output operations per second of the application, and a latency requirement of the application. A single resource usage level encompassing all sub-categories of I/O capacity usage may be predicted for the application.

At step 604, the information handling system may predict a second resource usage level of a second resource of the information handling system for the application. The second resource may be a different resource from the first resource, and the second resource usage level may be predicted similarly to the prediction of the first resource usage level described with respect to step 602. The first and second resource usage levels may, for example, be predicted for a particular time instance, such as an instance at which an event or action is expected to be performed by the application. As one example, the information handling system may determine that a first resource usage level for a processing capacity of the information handling system by the application is high, while the second resource level for an I/O capacity of the information handling system is low.

At step 606, the information handling system may adjust one or more performance parameters of the information handling system based on the predicted first and second resource usage levels of the first and second resources. For example, the information handling system may adjust a performance parameter associated with increasing a processing efficiency of the information handling system based on a predicted high usage level of processing capacity and low usage level of I/O capacity of the information handling system. Other performance parameters may include a power of a processor of the information handling system, a frequency of the processor of the information handling system, a computed frames per second of the information handling system, a displayed frames per second of the information handling system, a TOC of the information handling system, a refresh rate of a display of the information handling system, a brightness of a display of the information handling system, and other information handling system performance parameters. In some embodiments, predetermined adjustments to performance parameters and/or combinations of performance parameters may be established for predetermined combinations of resource usage levels of multiple resources. For example, a predetermined adjustment to a displayed and/or computed frames per second of the information handling system may be associated with a high graphics usage level of the application and a low I/O usage level of the application. In some embodiments, performance parameters for adjustment may be determined based further on a current configuration of performance parameters of the information handling system, such as a current displayed frames per second of the information handling system. In some embodiments, the method 600 may be repeated, such that resource usage levels for multiple resources are calculated for multiple instances in time and multiple adjustments to performance parameters are performed over the course of execution of the application. In some embodiments, performance parameters may be adjusted based on concurrent predicted resource usage levels for multiple applications.

Adjustment of performance parameters based on predicted resource usage levels of multiple resources by an application can help to allocate demanded resources to an application to enhance operation of the application, such as to reduce application slowdowns. For example, when operating a target application, such as 3DMark, with one or more other applications, such as Cinebench and/or Chrome, in the background performance improvements of up to and exceeding 6% may be realized. As one example, when a target application, such as 3DMark, is running with predicted resource usage level of medium for processing capacity, low for I/O capacity, and high for graphics capacity, an information handling system may adjust a frames per second, such as limiting a frames per second of a background application such as Chrome, based on the predicted resource usage levels to enhance operation of the application. A performance improvement of 3% may be realized in such a circumstance. Further adjustments to performance parameters, such as limiting a memory-mapped input/output (MMIO) on a CPU of the information handling system based on the predicted resource usage levels may further enhance performance, such as by an additional 3%.

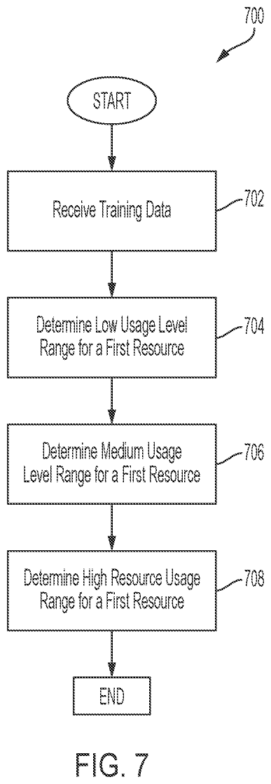

An information handling system may determine ranges for multiple resource usage levels for multiple resources of an information handling system by an application. An example method 700 for determining ranges for resource usage levels by an application is shown in FIG. 7. The method 700 may begin at 702 with receipt of training data. For example, the training data may include application data from execution of the application by the information handling system, such as process level data of the application, and usage data of the application, such as resource demands of the application when certain features of the application 404 are activated and information regarding a speed with which the application 404 responds to user requests. The training data may, for example, further include data regarding resource usage of multiple information handling system resources, such as a percentage of graphics capacity of the information handling system used by the application and/or a percentage of processing capacity of the information handling system used by the application when certain tasks are performed by the application. The training data may also include performance data regarding operation of the application, such as a speed with which the application responds to a user request when certain amounts of resources are allocated to the application. For example, the training data may include data regarding operation of the application and information handling system when the application is operating with various different resource requirement combinations. Training data regarding operation of the application under pure workloads, such as when an application requires 100% of a system resource capacity for only a single resource, impure workloads, such as when the application uses only one resource but at varying different percentages of the maximum capacity of the resource, and mixed workloads, such as when the application uses multiple resources at multiple different levels, may be collected. The training data may include process level data and usage data of other applications executed by the information handling system. The training data may include data regarding operation of the information handling system, such as resource usage of the information handling system, resource capacity of the information handling system, such as an amount of graphics capacity, processing capacity, and I/O capacity of the information handling system, telemetry data of the information handling system, such as temperature and power usage data of the information handling system, and other data regarding operation of the information handling system. In some embodiments, the training data may also include application and information handling system data received from the cloud, such as data gathered regarding operation of the application, or other applications, on other information handling systems.

At step 704, the information handling system may determine a low usage level range for a first resource of the information handling system. For example, the information handling system may determine a range in which a predicted usage of a first resource, such as processing capacity, by the application should be classified as a low resource usage. Determination of the range of usage may include determination of a range of a usage parameter, such as a percentage of a maximum capacity of the resource. Thus, a usage parameter may, for example, be a percentage of a capacity of a resource of the information handling system and may thus correspond to the resource. Determination of a range may include a determination of a threshold below which usage of the first resource by the application should be classified as low. In some embodiments, the low resource usage threshold may be determined based on a sensitivity of the application to adequate allocation of the resource. An application may be sensitive to adequate allocation of a resource if, for example, the application experiences substantial delays, freezes, or crashes if an inadequate amount of the resource is allocated to the application and/or if performance parameters associated with the resource are not tuned properly to the application's demand for the resource. For example, if the application is more sensitive to adequate allocation of the resource, a threshold below which a classification of a usage level of the resource will be low may be set lower, such as at 20% of the system's capacity of the first resource. If the application is less sensitive to adequate allocation of the resource, a threshold below which a classification of a usage level of the resource will be low may be set higher, such as at 50% of the system's capacity of the first resource. A similar process, at step 706, may be performed to determine a medium usage level range for the first resource, and at step 708, to determine a high resource usage range for the first resource. Such resource usage ranges may be used at steps 602 and 604 of the method 600 to predict a resource usage level of an application.

In some embodiments, the method 700 may be repeated multiple times to determine low, medium, and high resource usage levels by the application for multiple resources. In some embodiments, more than three ranges for resource usage levels may be determined to allow for further granularity in characterization of resource usage sensitivity by an application. In some embodiments, low, medium, and high resource usage levels may be determined for a resource for a class of applications, in place of or in addition to determination of such levels for a single application. In some embodiments, low, medium, and high resource usage levels may be further determined based on hardware capabilities of the information handling system, such as a maximum processing capacity, a maximum I/O capacity, a maximum graphics capacity, a maximum storage capacity, and a maximum network capacity of the information handling system. Thus, resource usage level ranges may be determined using an unsupervised machine learning algorithm based on past resource usage by an application and sensitivity of the application to adequate allocation of the resource to the application and tuning of parameters related to the resource.

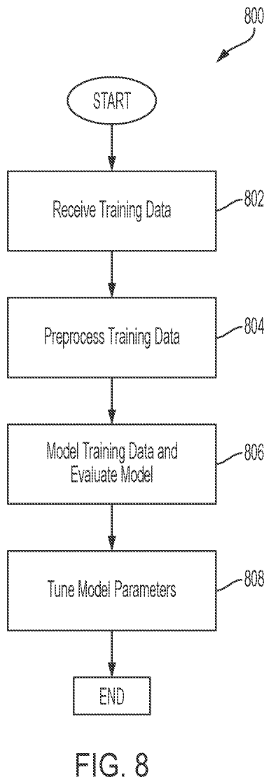

An example method 800 for operating a machine learning module, which may include a supervised machine learning model, to predict resource usage levels of an application is shown in FIG. 8. The method 800 may, for example, be performed by the resource usage prediction module 412 of FIG. 4. The method 800 may begin, at step 802, with receipt of training data. Training data may, for example, be training data as described with respect to step 702 of FIG. 7. For example, the training data may include data regarding operation of the application and information handling system when the application is operating with various different resource requirement combinations. In some embodiments, training data regarding operation of the application under pure workloads, such as when an application requires 100% of a system resource capacity for only a single resource, impure workloads, such as when the application uses only one resource but at varying different percentages of the maximum capacity of the resource, and mixed workloads, such as when the application uses multiple resources at multiple different levels, may be collected. Thus, data under different workloads may be received by the model while abstracting the hardware dependency of the data.

At step 804, the module may preprocess the training data. The training data may be received from multiple different sources such as first party data collection tools, data collection tools provided by third parties, and custom data collection tools, such as custom data collection tools for integrated graphics capabilities. Preprocessing the data may include cleaning the data by removing duplicates, correcting errors, handling missing values, normalizing the data, converting various data types to a common format, and other data cleaning operations. Preprocessing the data may also include randomizing the data, removing effects of the order in which the data was received, collected, or otherwise prepared. The model may also generate one or more visualizations of the collected data to aid users observing the model in determining relevant relationships between variables, detecting class imbalances, and performing other data analysis. The model may then split the data into a plurality of training and evaluation sets.

At step 806, the module may model the data and evaluate the model. For example, a multi-output machine learning model may be deployed to predict a level of resource usage by the application using the received training data. In some embodiments, the prediction may be class-specific. For example, the machine learning model may predict resource usage by an application based on a class of the application. Application classes may include content creation, content playback, streaming, collaboration, and specific CPU and I/O classes. The model may be evaluated after modeling the data, such as by using k-fold cross-validation. The model may also be tested against unseen data collected separately that was not collected or used in collection and use of the training data.

At step 808, the module may tune one or more parameters of the model. For example, hyperparameters such as a number of training steps, a learning rate, and other hyperparameters may be trained using a Bayesian optimization. The Bayesian optimization may, for example, follow sequential model-based optimization (SMBO) algorithms that allow for use of the results of previous iterations to improve sampling methods for further model training. Thus, a machine learning model may be employed to predict resource usage by an application of an information handling system.

The flow chart diagrams of FIGS. 6-8 are generally set forth as logical flow chart diagrams. As such, the depicted order and labeled steps are indicative of aspects of the disclosed method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagram, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

If implemented in firmware and/or software, functions described above may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise random access memory (RAM), read-only memory (ROM), electrically-erasable programmable read-only memory (EEPROM), compact disc read-only memory (CD-ROM) or other optical disk storage, magnetic disk storage or other magnetic storage devices, or any other medium that can be used to store desired program code in the form of instructions or data structures and that can be accessed by a computer. Disk and disc includes compact discs (CD), laser discs, optical discs, digital versatile discs (DVD), floppy disks and Blu-ray discs. Generally, disks reproduce data magnetically, and discs reproduce data optically. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and certain representative advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

What is claimed is:

1. A method for managing information handling system performance, comprising:
predicting, for a first time period, a first resource usage level of a first information handling system resource for an application;
predicting, for the first time period, a second resource usage level of a second information handling system resource different from the first information handling system resource for the application; and
adjusting one or more performance parameters for the information handling system based on the first resource usage level and the second resource usage level.

2. The method of claim 1, wherein predicting the first resource usage level comprises executing a supervised machine learning model to predict usage of the first resource.

3. The method of claim 1, wherein predicting the first resource usage level of the first information handling system resource comprises determining whether a first predicted usage of the first resource by the application should be classified as a low usage level of the first resource, a medium usage level of the first resource, or a high usage level of the first resource, and wherein predicting the second resource usage level of the second information handling system resource comprises determining whether a second predicted usage of the second resource by the application should be classified as a low usage level of the second resource, a medium usage level of the second resource, or a high usage level of the second resource.

4. The method of claim 3, further comprising:
determining a first range of a first usage parameter corresponding to the first information handling system resource for the low usage level;
determining a second range of the first usage parameter corresponding to the first information handling system resource for the medium usage level; and
determining a third range of the first usage parameter corresponding to the first information handling system resource for the high usage level.

5. The method of claim 4, further comprising:
receiving, by an unsupervised machine learning model of the information handling system, training data for training the machine learning model,
wherein the steps of determining the first range, the second range, and the third range are performed by the unsupervised machine learning model based, at least in part, on the received training data.

6. The method of claim 4, wherein the first range, the second range, and the third range are determined for a first application classification.

7. The method of claim 1, wherein adjusting the one or more performance parameters comprises one or more of:
adjusting a displayed frames per second of the information handling system;
adjusting a computed frames per second of the information handling system;
adjusting a power of a central processing unit (CPU) of the information handling system;
adjusting a frequency of the CPU of the information handling system;
adjusting a refresh rate of a display of the information handling system; or
adjusting a brightness of the display of the information handling system.

8. The method of claim 1, further comprising:
predicting, for a second time period, a third resource usage level of the first information handling system resource for the application;
predicting, for the second time period, a fourth resource usage level of the second information handling system resource for the application; and
adjusting the one or more performance parameters for the information handling system based on the third resource usage level and the fourth resource usage level.

9. The method of claim 1, wherein the first information handling system resource comprises at least one of a processing capacity of the information handling system, an input/output capacity of the information handling system, a storage capacity of the information handling system, a graphics capacity of the information handling system, or a network capacity of the information handling system.

10. An information handling system, comprising:
a processor; and
a memory,
wherein the processor is configured to perform steps comprising:
predicting, for a first time period, a first resource usage level of a first information handling system resource for an application;
predicting, for the first time period, a second resource usage level of a second information handling system resource different from the first information handling system resource for the application; and
adjusting one or more performance parameters for the information handling system based on the first resource usage level and the second resource usage level.

11. The information handling system of claim 10, wherein predicting the first resource usage level comprises executing a supervised machine learning model to predict usage of the first resource.

12. The information handling system of claim 10, wherein predicting the first resource usage level of the first information handling system resource comprises determining whether a first predicted usage of the first resource by the application should be classified as a low usage level of the first resource, a medium usage level of the first resource, or a high usage level of the first resource, and wherein predicting the second resource usage level of the second information handling system resource comprises determining whether a second predicted usage of the second resource by the application should be classified as a low usage level of the second resource, a medium usage level of the second resource, or a high usage level of the second resource.

13. The information handling system of claim 12, wherein the processor is further configured to perform steps comprising:
determining a first range of a first usage parameter corresponding to the first information handling system resource for the low usage level;
determining a second range of the first usage parameter corresponding to the first information handling system resource for the medium usage level; and
determining a third range of the first usage parameter corresponding to the first information handling system resource for the high usage level.

14. The information handling system of claim 13, wherein the processor is further configured to perform steps comprising:
receiving, by an unsupervised machine learning model of the information handling system, training data for training the machine learning model,
wherein the steps of determining the first range, the second range, and the third range are performed by the unsupervised machine learning model based, at least in part, on the received training data.

15. The information handling system of claim 13, wherein the first range, the second range, and the third range are determined for a first application classification.

16. The information handling system of claim 10, wherein adjusting the one or more performance parameters comprises one or more of:
adjusting a displayed frames per second of the information handling system;
adjusting a computed frames per second of the information handling system;
adjusting a power of a central processing unit (CPU) of the information handling system;
adjusting a frequency of the CPU of the information handling system;
adjusting a refresh rate of a display of the information handling system; or
adjusting a brightness of the display of the information handling system.

17. The information handling system of claim 10, wherein the processor is further configured to perform steps comprising:
predicting, for a second time period, a third resource usage level of the first information handling system resource for the application;
predicting, for the second time period, a fourth resource usage level of the second information handling system resource for the application; and
adjusting the one or more performance parameters for the information handling system based on the third resource usage level and the fourth resource usage level.

18. The information handling system of claim 10, wherein the first information handling system resource comprises at least one of a processing capacity of the information handling system, an input/output capacity of the information handling system, a storage capacity of the information handling system, a graphics capacity of the information handling system, or a network capacity of the information handling system.

19. A computer program product, comprising:
a non-transitory computer readable medium, wherein the non-transitory computer readable medium comprises instructions for causing a processor to perform steps comprising:
predicting, for a first time period, a first resource usage level of a first information handling system resource for an application;
predicting, for the first time period, a second resource usage level of a second information handling system resource different from the first information handling system resource for the application; and
adjusting one or more performance parameters for an information handling system based on the first resource usage level and the second resource usage level.

20. The computer program product of claim 19, wherein predicting the first resource usage level comprises executing a supervised machine learning model to predict usage of the first resource.
